(19) United States
(12) Patent Application Publication
(10) Pub. No.: US 2007/0039485 A1
(43) Pub. Date: Feb. 22, 2007

(54) Sealing and opening structure of a food container

(76) Inventor: Hsin-Hung Chou, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/206,835

(22) Filed: Aug. 19, 2005

(51) Int. Cl. A01J 15/14

(52) U.S. Cl. 99/467

(57) ABSTRACT

A sealing and opening structure of a food container having a main body and a top cover. The main body and the top cover include an opening with the outer rim forming a plurality of horizontal and vertical sides. In this way, the top cover can be attached to the top side of the main body with the connection surfaces of one of the horizontal sides or the vertical side forming a grooved-and-tongued joint. The invention features that an ear is formed at the outer rim of the second horizontal side of the main body. An opening handle corresponding to the ear of the top cover is extended outwardly from the fourth horizontal side while the opening handle is substantially triangular. Both sides relative to the center line (x-x) of the surface of the opening handle include a stiffening groove, and the external side of the top cover terminates at an edge portion extended downwardly from the outer rim of the opening handle. And a gap is formed between the edge portion of the opening handle and the ear of the main body for insertion of a finger. Accordingly, an excellent leakproofness and an easy opening of the top cover with less effort can be ensured.

### BACKGROUND OF THE INVENTION

1. Field of the Invention

The invention relates to a sealing and opening structure of a food container, and more particularly to a structure that employs a main body and a top cover that are formed in a plastic vacuum molding process and an injection molding process. By use of a specially designed opening handle, the top cover can be easily and rapidly lifted away from the main body with less effort. Accordingly, a practical use is ensured.

2. Description of the Related Art

There are various plastic containers formed in vacuum molding process. They features shape variations and little consumption of materials. For example, they are in shape of box, cup, bowl, and the like. Accordingly, they are especially suitable for the food preserving containers.

Foods have the wide variety of kinds. The fluid food such as fruit jelly, pudding, cheese, and the like are required to be transported from the manufacturing factories to the shops and carried from the shops to the consumers' houses. The food containers are needed to be sealed to prevent the food inside from leakage during the transport.

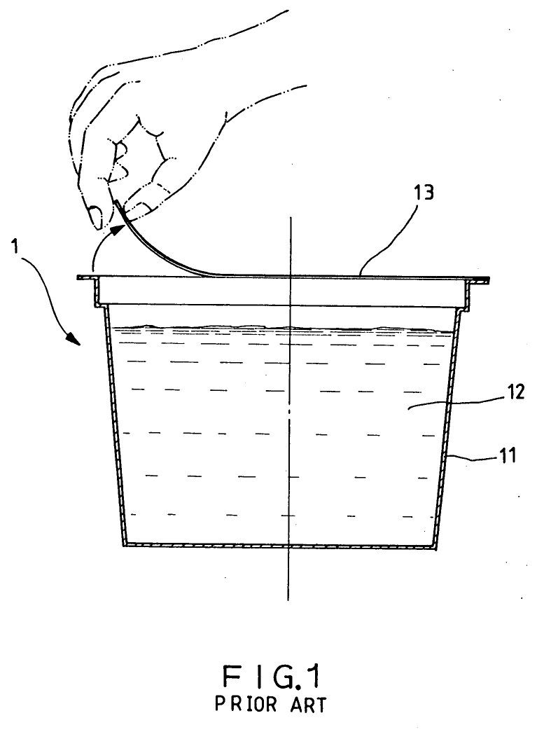

As shown in FIG. 1, a conventional food container 1 includes a cup body 11 in which fluid food 12 is contained. The cup body 11 is sealed with a plastic film or aluminum foil 13 for preventing the fluid food from leakage during the transport. However, the cup body 11 can't be sealed again to preserve the remaining food after a first use when the plastic film or aluminum foil 13 is pulled apart. This is the primary drawback for this structure.

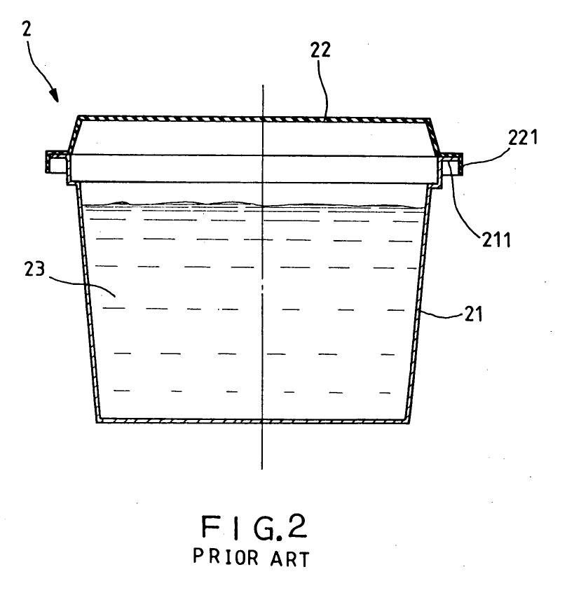

As shown in FIG. 2, another food container 2 has a cup body 21. A cap 22 formed in a vacuum molding process includes a fastening rim 221 that is attached to a flange 211 of the cup body 21 in place. This kind of food container 2 is suitable for the non-fluid food. However, it leaks the fluid food 23 easily due to the bad leakproofness. In order to protect the fluid food 23 from leakage, the joint surface between the fastening rim 221 and the flange 211 can be heated for an expected leakproofness. This causes, however, the users much inconvenience in use. Even, a scissor or a knife is needed to cut it off, thereby damaging the whole structure of the cap 22. So, the fluid food 23 can't be preserved in the cup body 21 any more.

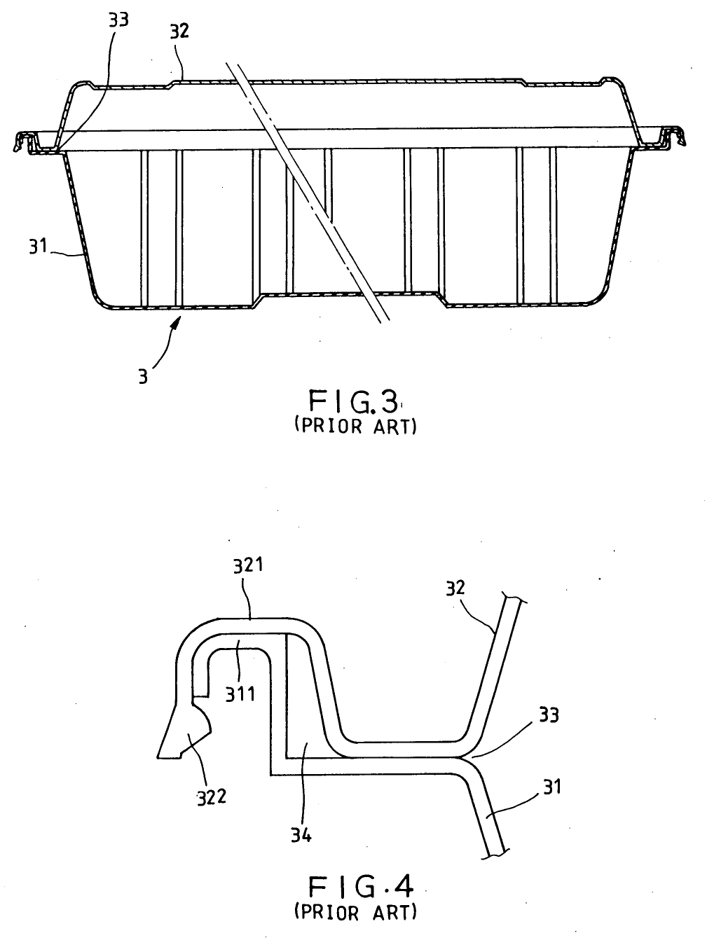

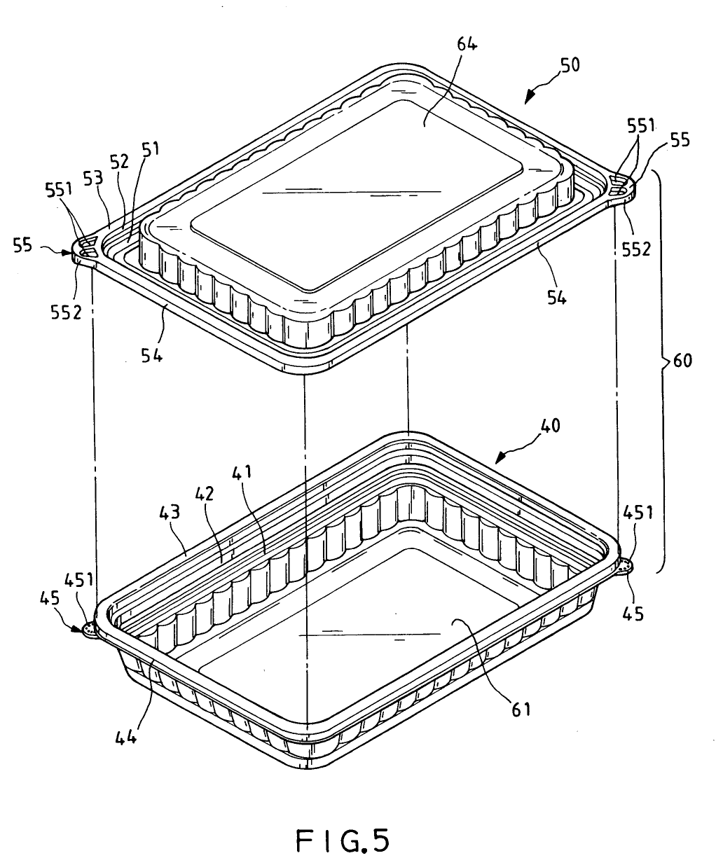

As shown in FIGS. 3 and 4, U.S. Pat. No. 6,056,138 teaches a “TRIPLE SEAL CONTAINER” that includes a main body 31. A cap 32 formed in a vacuum molding process includes a fastening rim 321 that is attached to a flange 311 of the main body 31 in place. Meanwhile, an inverted U-shaped yoke 321 employs a locking lip 322 that is hooked at a bottom side of the flange 311 in place. Unlike the structure in FIG. 2 that required a heat sealing process at the joint, the structure still has the following drawbacks:

1. The locking lip 322 of the cap 32 is hooked in an inverted manner to the bottom side of the flange 311. In opening the cap 32, the user has to use his fingers to lift the locking lip 322, thereby causing much pain in fingers. Even, the fingers can be injured through the opening action.

2. Although the locking lip 322 enhances a stable positioning of the cap 32 and the main body 31 so that the cap 32 is not easily removed from the main body 31. However, the cap 32 and the joint 33 of the main body 31 have a flat contact. Meanwhile, all containers formed in vacuum molding process have very thin walls with certain tension or strength that are insufficient for a close attachment and a perfect leakproofness. Therefore, the fluid food 35 within the main body 31 will leak from a gap 34 of the joint 33 when the main body 31 tips over. So, the leakproofness of the container leaves still much to be desired.

The inventor of the invention disclosed a “FOOD CONTAINER SEALING STRUCTURE” in U.S. Pat. No. 6,883,678 that resolves the problem of the bad leakproofness. However, its cap is still hard to be lifted.

### SUMMARY OF THE INVENTION

A primary object of the invention to eliminate the above-mentioned drawbacks and to provide a sealing and opening structure of a food container that includes a main body and a top cover with excellent leakproofness. By use of a specially designed opening handle, the top cover can be easily and rapidly lifted away from the main body with less effort. Accordingly, a practical use is ensured.

In order to achieve the above-mentioned objects, a sealing and opening structure of a food container comprises a main body and a top cover. The main body and the top cover include an opening with the outer rim forming a plurality of horizontal and vertical sides. In this way, the top cover can be attached to the top side of the main body with the connection surfaces of one of the horizontal sides or the vertical side forming a grooved-and-tongued joint. The invention features that an ear is formed at the outer rim of the second horizontal side of the main body, and an opening handle corresponding to the ear of the top cover is extended outwardly from the fourth horizontal side while the opening handle is substantially triangular, and both sides relative to the center line (x-x) of the surface of the opening handle include a stiffening groove, and the external side of the top cover terminates at an edge portion extended downwardly from the outer rim of the opening handle, and a gap is formed between the edge portion of the opening handle and the ear of the main body for insertion of a finger. Accordingly, an excellent leakproofness and an easy opening of the top cover with less effort can be ensured.

### BRIEF DESCRIPTION OF THE FIG.S

The accomplishment of this and other objects of the invention will become apparent from the following descriptions and its accompanying figures of which:

FIG. 1 is a schematic drawing of a conventional food container;

FIG. 2 is a schematic drawing of another conventional food container;

FIG. 3 is a schematic drawing of a further food container in accordance with U.S. Pat. No. 6,056,138;

FIG. 4 is a cutaway view of the structure of FIG. 3;

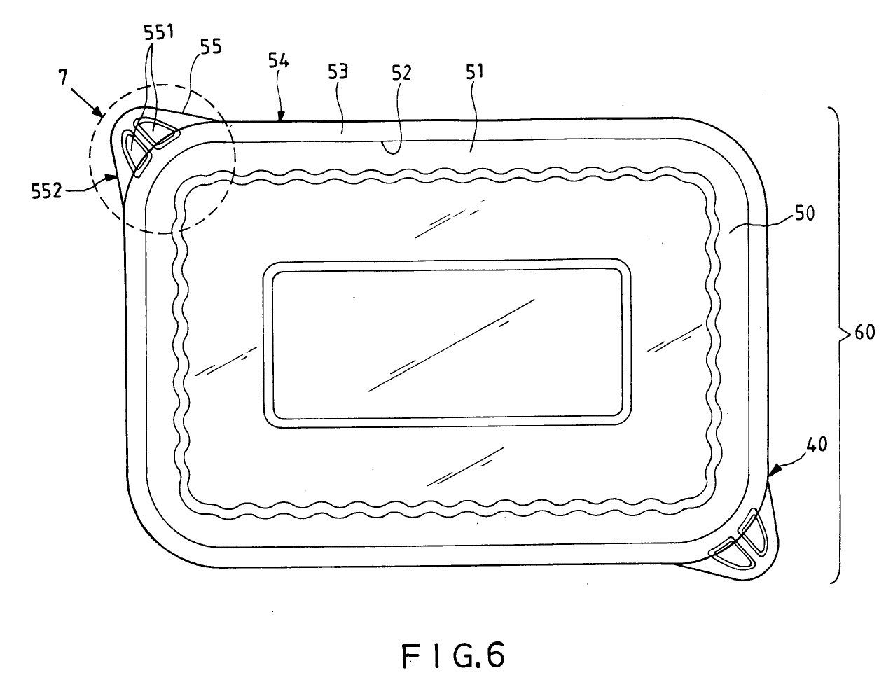

FIG. 5 is an exploded view of the invention after assembly;

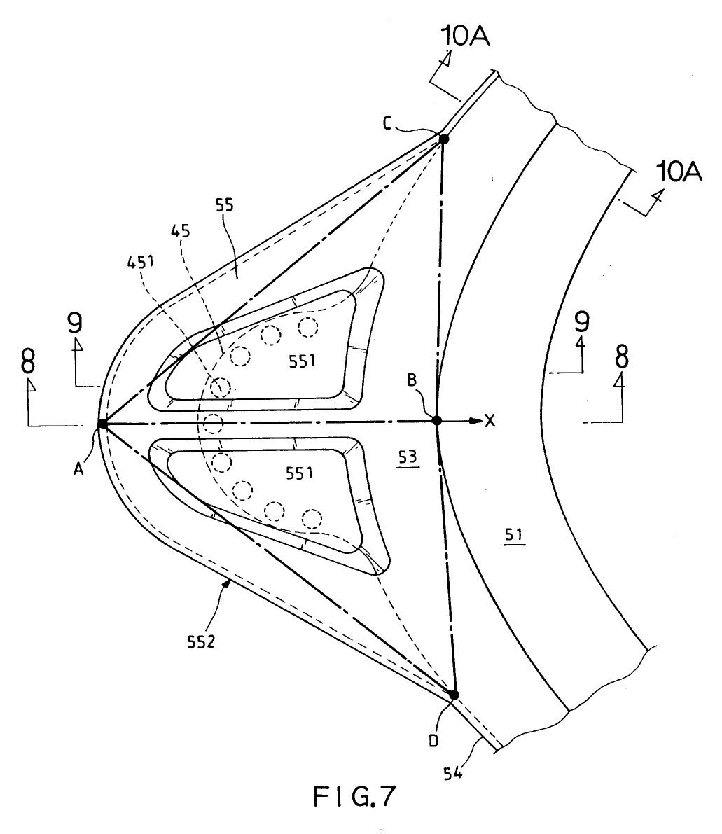

FIG. 6 is a top view of the invention in FIG. 5;

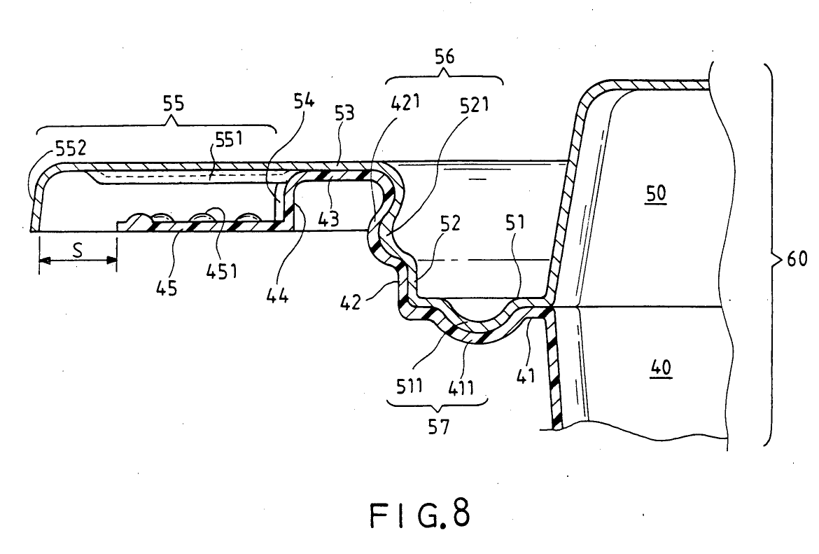

FIG. 7 is an enlarged view of a portion in FIG. 6;

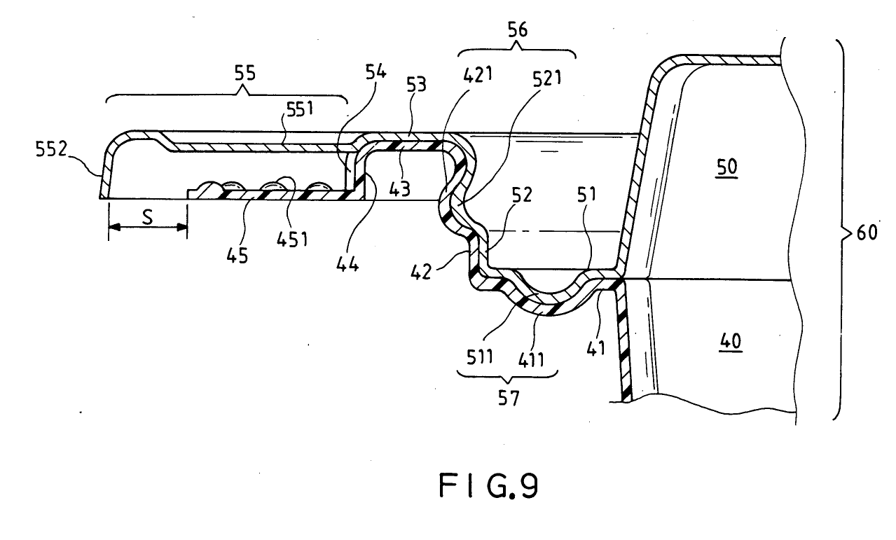

FIG. 8 is a cutaway view taken along the lines 8-8 of FIG. 7;

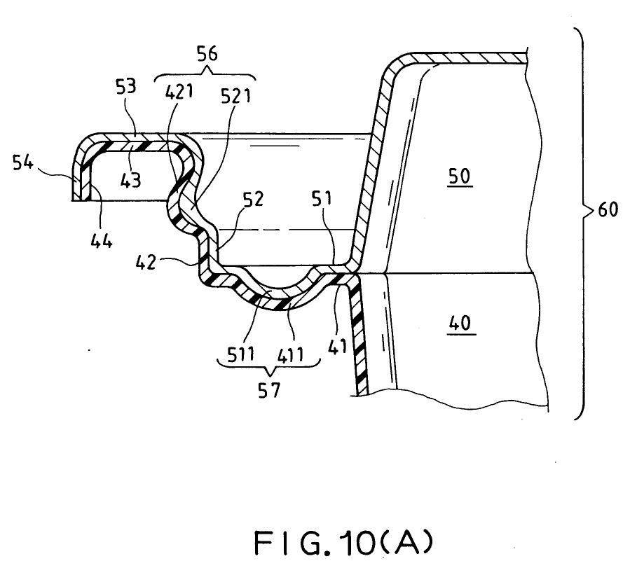

FIG. 9 is a cutaway view taken along the lines 9-9 of FIG. 7;

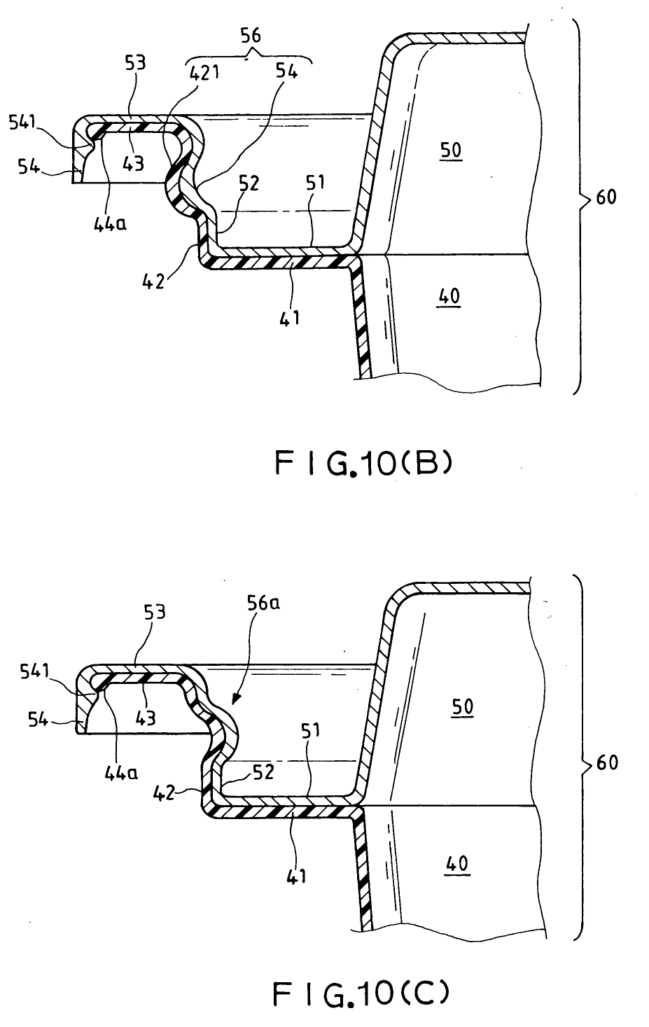

FIG. 10(A) is a cutaway view taken along the lines 10A-10A of FIG. 7;

FIG. 10(B) is a cutaway view of a grooved-and-tongued joint in accordance with another embodiment of the invention;

FIG. 10(C) is a cutaway view of a grooved-and-tongued joint in accordance with a further embodiment of the invention;

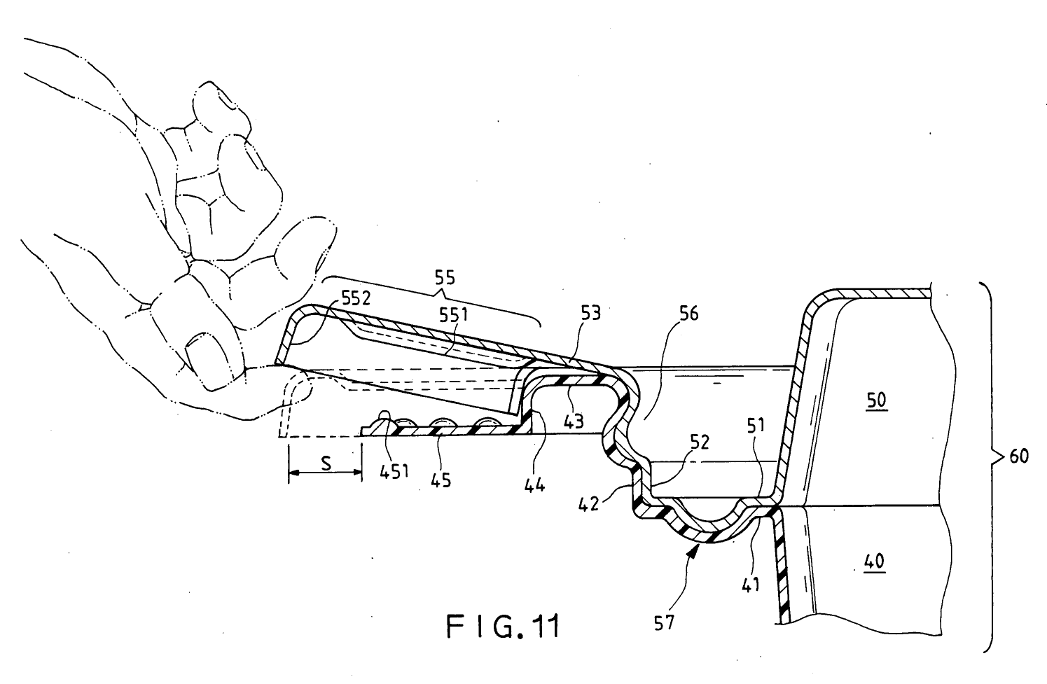

FIG. 11 is a cutaway view of the invention when the user employs his finger to lift the top cover;

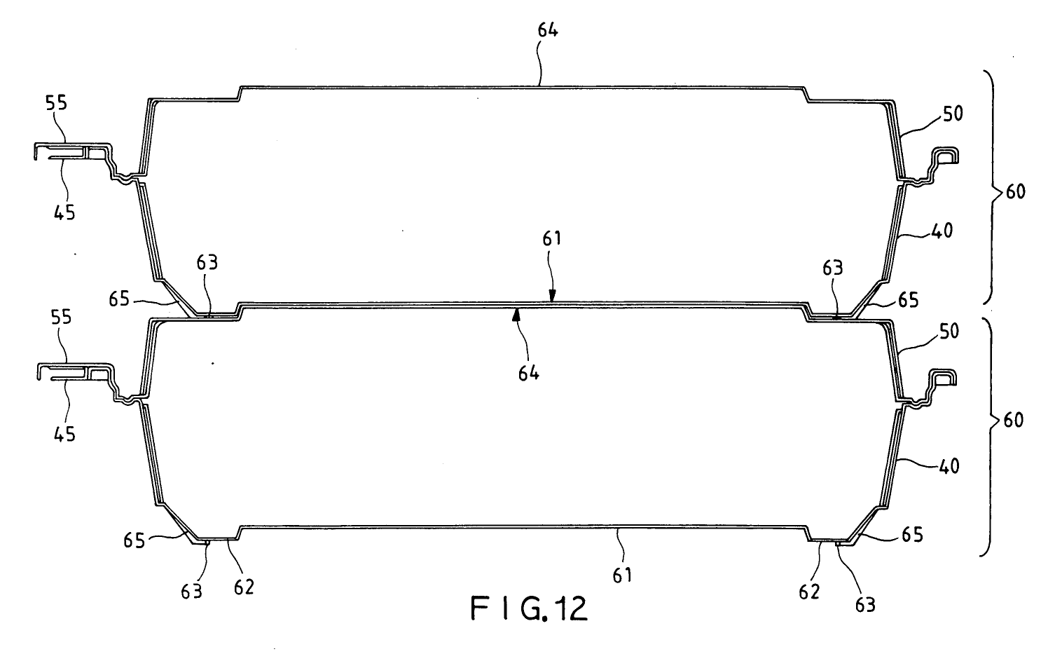

FIG. 12 is a cutaway view of the invention in stacked position;

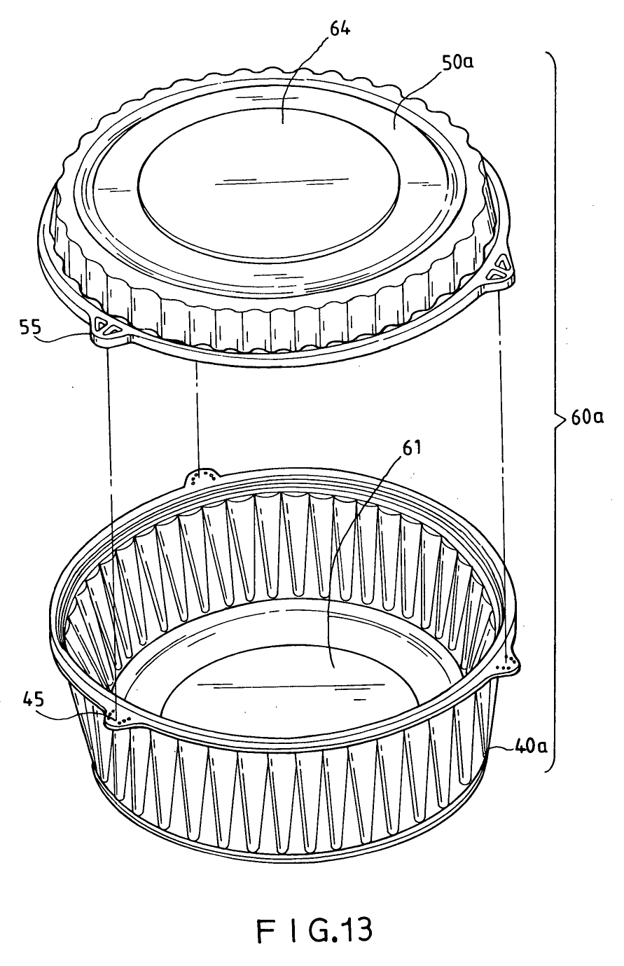

FIG. 13 is an exploded view of another embodiment of the invention; and

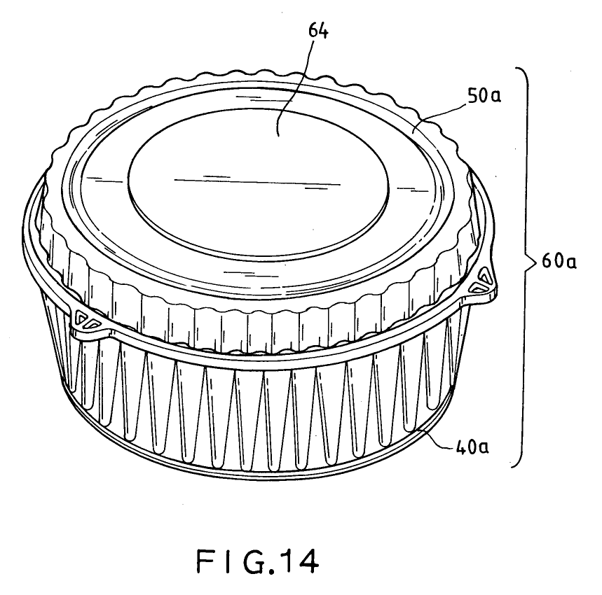

FIG. 14 is a perspective view of the embodiment in accordance with the invention in FIG. 13.

### DETAILED DESCRIPTION OF THE PREFERRED EMBODIMENT

First of all, referring to FIGS. 5 through 9, a food container 60 in accordance with the invention includes a main body 40 and a top cover 50. The main body 40 is constructed as a box. The main body 40 and the top cover 50 are formed in a plastic vacuum molding process or in an injection-molding process. The top cover 50 can be a transparent body. Also, the main body 40 can be transparent. No matter whether they are transparent or not, the main body 40 and the top cover 50 are thin and lightweight to allow the food container to meet the practical requirement.

How to make use of a sealing device of the food container 60 without increase of the volume and sacrifice of the practical use and how to easily open the sealed top cover 50 are main problems that the invention wants to resolve. The invention includes:

a main body 40 having an opening at a top side thereof, the outer rim of the opening forming a first horizontal side 41, the first horizontal side 41 terminating at a first vertical side 42, the first vertical side 42 extending upwardly to a second horizontal side 43; and

a top cover 50 having a bottom portion with an opening, the outer rim of the opening having a third horizontal side 51 and a fourth horizontal side 53 corresponding to the first horizontal side 41 and the second horizontal side 43 of the main body 40 as well as a second vertical side 52 corresponding to the first vertical side 42 of the main body 40.

Accordingly, the top cover 50 can be fitted into the top side of the main body 40 with the connection surfaces of one of the horizontal sides or the vertical side forming a grooved-and-tongued joint. An applicable embodiment of the invention is shown in FIGS. 8, 9 and 10. The first vertical side 42 of the main body 40 and the second vertical side 52 of the top cover 50 include a first concave portion 421 and a first convex portion 521, respectively, thereby forming a first grooved-and-tongued joint 56. Meanwhile, the first horizontal side 41 and the third horizontal side 51 includes a second concave portion 411 and a second convex portion 511, respectively, thereby forming a second grooved-and-tongued joint 57.

The first grooved-and-tongued joint 56 and the second grooved-and-tongued joint 57 can co-exist. As illustrated in FIG. 10B, only one first grooved-and-tongued joint 56 is formed. As shown in FIG. 10C, the first grooved-and-tongued joint 56a is concaved in an opposite direction. Moreover, the second horizontal side 43 of the main body 40 and the fourth horizontal side 53 of the top cover 50, as shown in FIG. 10A, terminate at a third vertical side 44 and a fourth vertical side 54 that are downwardly extended, respectively. Also, the third vertical side 44 of the main body 40, as shown in FIGS. 10B and 10C, can be changed into a protruding rim 44a that is downwardly extended while the fourth vertical side 54 of the top cover 50 includes an engaging portion 541 that is inwardly extended and corresponds to the protruding rim 44a. This design protects the top cover 50 from an easy loosening due to the fact that the food container 60 expands and contracts in response to changes in temperature.

The invention is characterized in that at least an ear 45 is formed at the outer rim of the second horizontal side 43 of the main body 40. The ear 45 includes a rough surface. In accordance with the embodiment of the invention, a plurality of knops 451 is arranged on the rough surface. Another configuration is also applicable.

Moreover, an opening handle 55 corresponding to the ear 45 of the top cover 50 is extended outwardly from the fourth horizontal side 53. The opening handle 55 is substantially triangular. As shown in FIG. 7, both sides relative to the center line (x-x) of the surface of the opening handle 55 include a stiffening groove 551. The fourth vertical side 54 of the top cover 50 terminates at an edge portion 552 extended downwardly from the outer rim of the opening handle 55. Meanwhile, a gap (S) is formed between the edge portion 552 of the opening handle 55 and the ear 45 of the main body 40 for insertion of a finger. Accordingly, as shown in FIG. 11, the gap (S) allows the finger of the user to hook the edge portion 552 of the opening handle 55 and, therefore, to exert an upward action force for removing the top cover 50. The rough surface consisting of the knops 451 on the ear 45 is used to receive fingers of another hand (not shown). So, the top cover 50 can be easily removed by lifting the opening handle 55.

Referring back to FIG. 7, a first effort arm ( A̅B̅) extends from a force-exerting point (A) along the center line (x-x) inwardly to the internal end of the fourth horizontal side 53. A second and a third effort arm ( A̅C̅, A̅D̅) extend from the force-exerting point (A) to points (C, D) where both sides of the opening handle 55 are connected to the main body 40, respectively. When a lifting force exerted by the finger acts on the force-exerting point (A), a very large triangular force-exerting point (A) is formed since the whole opening handle 55 includes the edge portion 552 where the fourth vertical side 54 ends as well as two stiffening grooves 551 on the surface of the opening handle 55. In this way, the top cover 50 can be lifted along the cutting points (C, D) away from the main body 40, as illustrated in FIG. 11.

The top cover 50 of the invention employs the first grooved-and-tongued joint 56 and even the second grooved-and-tongued joint 57 to be sealed on the main body 40. Meanwhile, the opening handle 55 and the ear 45 allow the user to easily open the top cover 50 with less effort.

As shown in FIG. 12, the main body 40 includes a bottom concave portion 61. Moreover, a plurality of protrusions 63 is formed on the bottom surface 62 around the bottom concave portion 61. The top cover 50 includes a top convex portion 64 corresponding to the concave portion 61 of the main body 40 for a grooved-and-tongued joint. In this way, the food containers 60 can be stacked one another. Meanwhile, the protrusions 63 protect the food container 60 from sticking to each other. In addition, the protrusion 63 contains a slope 65 at the external side of the main body 40, and the slope 65 has a concave-convex surface for enhancing the strength of the main body 40 and ensuring heat insulation.

As shown in FIGS. 13 and 14, the invention is applicable to the food container 60a in a round shape. That is, the main body 40a and the top cover 50a are round. Meanwhile, the ear 45 and the opening handle 55 are disposed at a prearranged position. Besides, the bottom concave portion 61 and the top convex portion 64 are formed to create a grooved-and-tongued joint for an easy stacking. The features are similar to that of the above-mentioned rectangular container 60 so that no further descriptions are given hereinafter.

Many changes and modifications in the above-described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A sealing and opening structure of a food container, comprising:
a) a main body having an opening at a top side thereof, the outer rim of the opening forming a first horizontal side, the first horizontal side terminating at a first vertical side, the first vertical side extending upwardly to a second horizontal side; and
b) a top cover having a bottom portion with an opening, the outer rim of the opening having a third horizontal side and a fourth horizontal side corresponding to the first horizontal side and the second horizontal side of the main body as well as a second vertical side corresponding to the first vertical side of the main body whereby the top cover can be attached to the top of the main body with the connection surfaces of one of the horizontal sides or the vertical side forming a grooved-and-tongued joint;
wherein an ear is formed at an outer rim of the second horizontal side of the main body, and the ear includes a rough surface;
wherein an opening handle corresponding to the ear of the top cover is extended outwardly from the fourth horizontal side while the opening handle is substantially triangular, and both sides relative to the center line (x-x) of the surface of the opening handle include a stiffening groove, and the external side of the top cover terminates at an edge portion extended downwardly from the outer rim of the opening handle, and a gap is formed between the edge portion of the opening handle and the ear of the main body for insertion of a finger; and
wherein a first effort arm ( A̅B̅) extends from a force-exerting point (A) along the center line (x-x) inwardly to the internal end of the fourth horizontal side, and a second and a third effort arm ( A̅C̅, A̅D̅) extend from the force-exerting point (A) to points (C, D) where both sides of the opening handle are joined to the main body, respectively so that the top cover may be lifted along the cutting points (C, D) away from the main body.

2. The sealing and opening structure of a food container as recited in claim 1 wherein the first vertical side of the main body and the second vertical side of the top cover includes a first concave portion and a first convex portion, respectively, thereby forming a first grooved-and-tongued joint.

3. The sealing and opening structure of a food container as recited in claim 1 wherein the first horizontal side and the third horizontal side includes a second concave portion and a second convex portion, respectively, thereby forming a second grooved-and-tongued joint.

4. The sealing and opening structure of a food container as recited in claim 1 wherein the second horizontal side of the main body and the fourth horizontal side of the top cover terminate at a third vertical side and a fourth vertical side, respectively, that are downwardly extended.

5. The sealing and opening structure of a food container as recited in claim 1 wherein the external end of the second horizontal side of the main body includes a protruding rim that is downwardly extended while the external side of the fourth horizontal side of the top cover includes a fourth vertical side that is downwardly extended, and the inside wall of the fourth vertical side includes an engaging portion that is inwardly extended and corresponds to the protruding rim.

6. The sealing and opening structure of a food container as recited in claim 1 wherein the rough surface on the ear of the main body consists of a plurality of knops in rows.

7. The sealing and opening structure of a food container as recited in claim 1 wherein the main body includes a bottom concave portion, and a plurality of protrusions is formed on the bottom surface around the bottom concave portion, and the top cover includes a top convex portion corresponding to the concave portion of the main body for a grooved-and-tongued joint.
